(19) United States
(12) Patent Application Publication
(10) Pub. No.: US 2007/0293643 A1
(43) Pub. Date: Dec. 20, 2007

(54) HEXAFLUOROPROPENE-BASED FLUOROSULFONATED ELASTOMERS WITH A LOW GLASS TRANSITION TEMPERATURE, CONTAINING NEITHER TETRAFLUOROETHYLENE NOR A SILOXANE GROUP

(75) Inventors: Bruno Michel Ameduri, Montpellier (FR); Michel Armand, Montreal (CA); Mario Boucher, St-Etienne-des-Gres (CA); Abdellatif Manseri, Montpellier (FR)

Correspondence Address: OBLON, SPIVAK, MCCLELLAND MAIER & NEUSTADT, P.C., 1940 DUKE STREET, ALEXANDRIA, VA, 22314, US

(73) Assignee: HYDRO-QUEBEC, Montreal (CA)

(21) Appl. No.: 11/779,551

(22) Filed: Jul. 18, 2007

Related U.S. Application Data
(63) Continuation of application No. 11/182,858, filed on Jul. 18, 2005, now abandoned.
Application No. 11/182,858 is a continuation of application No. 10/168,525, filed on Nov. 26, 2002, now abandoned.

(30) Foreign Application Priority Data
Dec. 29, 1999 (CA) 2,293,845
Feb. 24, 2000 (CA) 2,299,621

(51) Int. Cl. C08F 14/26; C08F 2/00

(52) U.S. Cl. 526/206; 526/212; 526/227; 526/230.5; 526/243; 526/89

(57) ABSTRACT

The present invention describes the synthesis of new fluorinated elastomers with very low glass transition temperatures (T_{g}), a good resistance to bases, gasoline and other carburants and good workability properties, these elastomers contain hexafluoropropene (HFP), perfluoro(4-methyl-3,6-dioxaoct-7-ene) sulfonyl fluoride (PFSO₂F), vinylidene fluoride (VDF) and/or at least one fluorinated alkene and/or one vinyl perfluorinated ether. In a precise case, they are prepared by radical polymerisation of HFP and PFSO₂F or by radical terpolymerisation HFP, PFSO₂F and VDF in the presence of different organic initiator, such as peroxides, peresters or diazo compounds.

### FIELD OF INVENTION

The present invention concerns the synthesis of new fluoro elastomers having very low glass transition temperatures (T_{g}), with a good resistance to acids, oil and fuels, along with good workability properties. The elastomers of this invention contain hexafluoropropene (HFP), perfluoro (4-methyl-3,6-dioxaoct-7-ene) sulfonyl fluoride (PFSO₂F), and vinylidene fluoride (VDF) and/or perfluoro vinyl ether and/or a fluoro alkene. These elastomers are prepared by radical copolymerisation of HFP with PFSO₂F or radical terpolymerisation of HFP with PFSO₂F and VDF in the presence of different conventional organic initiators, such as the peroxides, the peresters, the diazo compounds or the alkyl peroxypivalates.

### DESCRIPTION OF THE PRIOR ART

Fluorinated elastomers offer a unique combination of extremely advantageous properties. Among these, are their thermal resistance, to oxidation, by ultraviolet rays (UV), to the degradation due to ageing, corrosive chemical agents and fuels. They possess, among other things, low surface tensions, dielectric constants and refractive indexes. In addition, they resist the absorption of water. All these properties make them materials of choice in diverse applications of high technology such as components of fuel cells, seals in the aeronautical field, semiconductors in microelectronics, hoses, pipes, pump casings and diaphragms in the chemical, automotive and petroleum industries.

However, hexafluoropropene (HFP) elastomers are not numerous. Despite the fact that commercial elastomers such as Fluorel®, Dai-El®, FKM®, Technoflon®, Viton®A or Viton®B (VDF/HFP or VDF/HFP/TFE) offer good chemical and thermal resistances, their glass transition temperatures (T_{g}) are not sufficiently low. The T_{g} of the aforementioned products generally vary between −10 and −25° C. The lowest value found in the literature is that that of Viton®B, whose T_{g} is −26° C., which is surprising because the manufacturer claims a T_{g} varying between −5 and −15° C. for this product. To compete with these elastomers, the company Ausimont offers a copolymer VDF/pentafluoropropene (Technoflon®) resistant to flames and oxidation, but not having a T_{g} lower than −26° C. and consequently the comonomer is difficult to obtain.

It is well known that copolymers containing HFP with tetrafluoroethylene (TFE) are thermoplastics, while the introduction of another fluorinated monomer such as, for example, trifluorovinyl ethers bring about the elastomeric character. DuPont has suggested a new generation of elastomers based on perfluoroalkyl vinyl ether (PAVE) but which do not contain HFP, and which are resistant to low temperatures, thus copolymers have been produced, such as the copolymers of tetrafluoroethylene (TFE)/perfluoromethyl vinyl ether (PMVE) (Kalrez®), of which the T_{g} do not go below −15° C., the TFE/PMVE described in EP 0 077 998, of which the T_{g} are −9° C., or TFE/perfluoroalkylvinylether (PAVE) described in U.S. Pat. No. 4,948,853. But it is mainly the terpolymers which offer even lower T_{g}'s. Among them, we note the terpolymer TFE/ethylene/PMVE of which the T_{g} is −17° C., or the terpolymer TFE/VDF/PAVE (described in EP 0 131 308), and especially the terpolymer TFE/VDF/PMVE (Viton GLT®) where the T_{g} is −33° C.

Moreover, elastomers containing TFE/PAVE/VDF, used as O-rings give very good resistance to polar solvents (EP 0 618 241, Ausimont and Japanese Patent -A-3066714 Chem. Abstr., 115:73436z).

The terpolymerisation of TFE with PMVE and F₂C═CF[OCF₂CF(CF₃)]ₙOC₃F₇ (Polym. J, 1985, 17, 253) conferred to the elastomers a T_{g} (of −9 to −76° C.) and is dependant on the value of the subscript n in the HFPO and to the percentage of the two oxygenated comonomers.

DuPont has also moreover produced Nafion® membranes by the copolymerisation of TFE with F₂C═CFOCF₂CF(CF₃)OC₂F₄SO₂F (PFSO₂F). In addition, Asahi Glass uses the same sulfonated monomer for the fabrication of Flemion® membranes. Other monomers with the same functionality are, for example F₂C═CFOCF₂CF(CF₃)OC₃F₆SO₂F (for Aciplex® membranes, by Asahi Chemical), or CF₂═CFOC₂F₄SO₂F, where the functionality is a carboxylated F₂C═CFO[CF₂CF(CF₃)O]ₓC₂F₄CO₂CH₃ (for Nafion® membranes or Aciplex® where x equals 1 and for Flemion® membranes if x equals 0) are also used.

The copolymerisation of HFP with other fluorinated olefins is well known, but the olefins used are PAVE, which are essentially perfluoromethyl vinyl ether (PMVE) or 2-bromoperfluoroethyl perfluorovinyl ether as cited in patents EP 410 351 and CA 2,182,328.

Moreover, EP 0 525 685 describes the synthesis of terpolymers HFP/PMVE/VDF leading to elastomers having a T_{g} equal to −27° C. (the lowest possible value) contrary to copolymers VDF/HFP where the T_{g} is −23° C. In WO 9220743 which describes the synthesis of terpolymers VDF/HFP/F₂C═CFO(CF₂)ₙCF₃ (where n varies between 0 and 5) obtained in the presence of a transfer agent (1,4-diiodoperfluorobutane), subsequently reticulated with peroxides.

It is especially the tetrapolymers containing TFE, VDF, HFP and PAVE which were produced. For example, DE 2,457,102 describes the preparation of tetrapolymers HFP/PMVE/TFE/VDF by emulsion copolymerisation. EP 0 525 687 relates to the synthesis of polymers HFP/PAVE/VDF/TFE presenting good chemical resistance and good workability (for examples for molding). Analogous properties have been seen in tetrapolymers containing HFP/PAVE/VDF and olefines having 2 to 4 carbon atoms (see EP 0 570 762). Moreover, CA 2,068,754 gives the state of pentapolymers HFP/VDF/TFE/PMVE/ethylene of which the T_{g} varies between −9 and −18° C., and as low as −28° C. when the monomer F₂C═CFOC₂F₄Br also participates in this polymerisation (hexapolymerisation). By the same token, the reticulated polymers containing HFP, VDF, TFE and precipitated brominated monomer have been described in EP 0 410 351 and in CA 2,182,328 or in articles Rubber Chem. Technology, 1982, 55, 1004 and Kautsch. Gummi Kunstst., 1991, 44, 833.

The addition of a non conjugated diene H₂C═CHC₄F₈CH═CH₂ in the preceding polymerisations favours the reticulation of these elastomers, as indicated in DE 4,137,967 and EP 0 769 521.

In addition, U.S. Pat. No. 3,282,875 concerns the terpolymers containing HFP, VDF and PFSO₂F but containing a very low proportion of sulfonated monomer, between 1 and 2%. It is important to know that the concentration of PFSO₂F in the polymers was determined by elemental analysis. Moreover, the T_{g} of the terpolymers is not mentioned.

Finally, the polymerisations containing HFP, PMVE and other fluorinated alkenes was conducted in supercritical CO₂ medium (U.S. Pat. No. 5,674,957).

It would thus be desirable to develop new elastomers having a very low glass transition temperature and obtained using inexpensive comonomers such as HFP. These elastomers would preferably be obtained through a simple process not requiring dangerous experimental conditions.

### DISCLOSURE OF THE INVENTION

The present invention consists of fluorinated elastomers comprising neither tetrafluoroethylene (TFE), nor monomers containing siloxane groups, and having glass transition temperatures (T_{g} between −36 and −50° C. and comprising hexafluoropropene (HFP) monomer and a comonomer of perfluorosulfonyl ethoxy propyl vinyl ether fluoride (PSEPVE) or perfluoro (4-methyl-3,6-dioxaoct-7-ene) sulfonyl fluoride (PFSO₂F).

The fluorinated elastomers according to this invention can also comprise vinylidene fluoride (VDF) and/or fluorinated alkenes and/or vinyl perfluorinated ethers.

Another object of the invention is to learn in a precise non-ambiguous manner the composition of the copolymers according to the invention, i.e. the molar percentages of each of the comonomers present in the copolymers and the terpolymers.

In a preferred embodiment, the elastomer contains less than 50 mole % of HFP, and preferably between 10 and 35 mole %, 15 to 80 mole % of PFSO₂F, and between 0 and 75 mole % of VDF and/or fluorinated alkenes and/or vinyl perfluorinated ethers.

The invention also concerns a process for the preparation of fluorinated elastomers by copolymerisation of hexafluoropropene (HFP) with perfluorosulfonyl ethoxy propyl vinyl ether fluoride (PSEPVE) or perfluoro (4-methyl-3,6-dioxaoct-7-ene) sulfonyl fluoride (PFSO₂F), characterised with a preparation through radical copolymerisation in the presence of an organic initiator and at a temperature between 20 and 200° C., for a period of approximately 2 and 6 hours, and an initial pressure between 2 and 100 bars, with the said pressure allowed to fall progressively while the monomers are consumed.

### DETAILED DESCRIPTION OF THE INVENTION

In view of the prior art, HFP was chosen for the preparation of elastomers according to this invention, because it was less expensive and more workable than TFE. Being less expensive, it can be used in larger quantities in the copolymer, and can be comprised of a second monomer perfluorosulfonyl ethoxy propyl vinyl ether fluoride (PSEPVE) or the perfluoro (4-methyl-3,6-dioxaoct-7-ene) sulfonyl fluoride (PFSO₂F). The use of HFP confers on the polymers formed improved elastomeric character and improved resistance to chemical agents, petroleum, and to oxidation.

The present invention also comprises terpolymers where the third comonomer is preferably VDF, this monomer leads to a low T_{g}, being inexpensive and easily workable, copolymerised (reactive) with free radicals; the PVDF groups in the polymer bring extra chemical and thermal inertia as well as better resistance to ageing.

The present invention preferably concerns the synthesis of novel fluorinated copolymer elastomers, containing hexafluoropropene and perfluorosulfonyl ethoxy propyl vinyl ether fluoride or perfluoro (4-methyl-3,6-dioxaoct-7-ene) sulfonyl fluoride, and possibly other fluorinated alkenes, and/or vinylidene fluoride and/or vinyl perfluorinated ethers. Among the advantages of the present invention:
The synthesis of fluorinated elastomers containing PSEPVE or PFSO₂F and possibly VDF, perfluorinated alkenes and vinyl perfluorinated ethers, is achieved with HFP instead of more expensive tetrafluoroethylene (TFE).
The synthesis of the fluorinated elastomers of the present invention do not require the use of monomers containing siloxane groups, which generally contribute to the lowering of the T_{g}. It is indeed well known that siloxanes have very low T_{g}. For example, the poly(dimethyl siloxane)s have T_{g} of −120° C. as indicated in a general manner in the following work: The Siloxane Bond: Physical Properties and Chemical Transformations, M. G. Voronkov, V. P. Mileshkevich, and Yu. A. Yuzhelevskii, Consultants Bureau, New York (1978).
The fluorinated elastomers of the present invention possess very low T_{g} which, for example, generally vary between −35 and −50° C., these elastomers can find applications in the plastics industry an implementation agent, and in other advanced technology industries such as aerospace, electronics or the automobile industry, petroleum, or the transport of very cold fluids such as liquid nitrogen, liquid oxygen and liquid hydrogen. Moreover, these high thermal resistant seals can be prepared from known elastomers. Finally, these elastomers can be used for the manufacture of material in the field of energy, for example the preparation of fuel cell components such as the membranes.

The field of the present invention extends to all types of general process uses: emulsion, miniemulsion, microemulsion, mass, suspension, microsuspension and solution polymerisations. All can be used according to their conventional means, but solution polymerisation was used preferentially, uniquely for reasons of simplifying laboratory operations, because in the case of solution polymerisation, the operating pressures are fairly low, in the order of 20 to 40 bars. In the case of emulsion, mass and suspension polymerisation, the operating pressure is higher, in the order of 40 to 100 bars.

The various fluorinated alkenes employed contain more than four carbon atoms and have the following structure R₁R₂C═CR₃R₄ where at least one of the substituents R₁₋₄ are fluorinated or perfluorinated. This encompasses: vinyl fluoride (VF), vinylidene fluoride (VDF), trifluoroethylene (TFE), chlorotrifluoroethylene (CTFE), bromotrifluoroethylene, 1-hydropentafluoropropylene, hexafluoroisobutylene, 3,3,3-trifluoropropene, 1,2-dichlorodifluoroethylene, 2-chloro-1,1-difluoroethylene, 1,2-difluoroethylene, 1,1-difluorodichloroethylene and generally all vinyl fluorinated and perfluorinated compounds. In addition, these perfluorinated vinyl ethers can also play a role as comonomers. Among these vinyl ethers, we can cite the perfluoroalkyl vinyl ethers (PAVE) where the alkyl group has between one and three carbon atoms: for example, perfluoromethyl vinyl ether (PMVE), perfluoroethyl vinyl ether (PEVE) and perfluoropropyl vinyl ether (PPVE). These monomers can also be perfluoroalkoxy alkyl vinyl ethers (PAAVE), described in U.S. Pat. No. 3,291,843 and in the review Prog. Polym. Sci., M. Yamabe et coll., 1986, 12, 229 and A. L. Logothetis, 1989, 14, 251, such as perfluoro(2-n-propoxy)propyl vinyl ether, perfluoro(2-methoxy)propyl vinyl ether, perfluoro(3-methoxy)propyl vinyl ether, perfluoro(2-methoxy)ethyl vinyl ether, le perfluoro(3,6,9-trioxa-5,8-dimethyl)-dodeca-1-ene, perfluoro(5-methyl-3,6-dioxo)-1-nonene. Moreover, perfluoroalkoxyalkyl vinyl ethers monomers carboxylic end-groups or sulfonyl fluoride end-groups, such as perfluoro(4-methyl-3,6-dioxaoct-7-ene) sulfonyl fluoride, can also be used for the synthesis of the fluorinated elastomers described by this invention. Mixtures of PAVE and PAAVE can also be present in copolymers.

The preferred solvents to carry out the solution polymerisation are advantageously conventional solvents comprising:
esters of formula R—COOR′ where R and R′ are independently C₁₋₅ alkyl groups, or ester OR″ where R″ is an alkyl containing 1 to 5 carbon atoms, R can also be represented as an H. Preferably, R=H or CH₃ and R′=CH₃, C₂H₅, i-C₃H₇ or t-C₄H₉.
Fluorinated solvents of the type ClCF₂CFCl₂, perfluoro-n-hexane (n-C₆F₁₄), n-C₄F₁₀, perfluoro-2-butyl-tetrahydro-furanne (FC 75™); and
Usual solvents such as 1,2-dichloroethane, isopropanol, tertiary butanol, acetonitrile and butyronitrile.

The preferred solvents are methyl acetate, acetonitrile and perfluoro-n-hexane in quantities varying from 30 to 60% by weight.

The reaction temperature for the copolymerisation is preferably situated between 20 and 200° C., more preferably between 55 and 140° C. The pressure inside the polymerisation autoclave varies preferably between 2 and 100 bars, and more preferably between 10 and 100 bars, and even more preferably between 20 and 35 bars, according to experimental conditions. Although the interval above are indicative, a person skilled in the art could make appropriate changes as a function by the properties being sought for the elastomers.

According to the process of the invention, the polymerisation can be initiated through the intervention of usual free radical polymerisation initiators. Representative examples of such initiators are azo compounds (such as AIBN), dialkyl peroxydicarbonates, acetylcyclohexanesulfonyl peroxide, dibenzoyl peroxide, alkyl peroxide, alkyl hydroperoxides, dicumyl peroxide, alkyl perbenzoates and alkyl peroxypivalates. Nevertheless, the preference is given to dialkyl peroxydicarbonates, such as diethyl and di-isopropyl peroxydicarbonates and to alkyl peroxypivalates such as t-butyl, t-amyl peroxypivalates and alkyl peroxide, and most particularly still to alkyl peroxypivalates. Preferably, the initial molar ratio between initiator and monomers is between 0.3 and 2%.

For the emulsion polymerisation process, a large range of co-solvents can be envisaged, the solvents being present in a wide range of mixed proportions with water, for example from 30 to 70% by weight. By the same token, anionic, cationic and non-ionic surfactants can be used in quantities varying usually between 1 and 3% by weight. In the emulsion or suspension polymerisation process, water is generally used as a reaction medium. However, the fluorinated monomers are only partially soluble in water, therefore there is a need to use surfactants. In addition, in the emulsion and suspension polymerisation process, a co-solvent can be added to increase the solubility of the fluorinated comonomers. In this case, acetonitrile, acetone or alkyl alkyl ketones such as methyl ethyl ketone, for example, can be employed.

One of the polymerisation processes that can be used is microemulsion as described in EP 0 250 767 or by dispersion, as indicated in U.S. Pat. No. 4,789,717; EP 0 196 904; EP 0 280 312 and EP 0 360 292.

Chain transferring agents can generally be used to regulate and principally reduce the molar masses of the copolymers. Among these, we can cite telogens containing 1 to 10 carbon atoms and terminal bromine or iodine atom such as for example the compounds of type R_{F}X (where R_{F} is a perfluorinated group, R_{F}═CₙF₂ₙ₊₁, n=1-10, X designating either a bromine or iodine atoms) or alcohols, ethers, or esters. A diverse list of transfer agents used in telomerization of fluorinated monomers is given in the review “Telomerization reactions of Fluoroalkanes”, B. Améduri and B. Boutevin in the work “Topics in Current Chemistry” (Ed. R. D. Chambers), vol. 192 (1997) p. 165, Springer Verlag 1997.

The elastomers of the present invention can be reticulated using peroxide based systems and triallyl(iso)cyanurate when such copolymers contain iodine and/or bromine atoms at the terminal position of the macromolecule. Peroxide systems are well known as described in EP 0 136 596.

Also, given the presence of sequences of VDF-HFP in the terpolymers, the fluorinated elastomers of this invention, can be reticulated by diamines, bis-amidoximes or polyphenols. These reticulations are described in Rubber World, 1960, 142, 103; U.S. Pat. No. 4,487,878; Prog. Polym. Sc., 1989, 14, 251; U.S. Pat. No. 5,668,221; Angew. Makromol. Chem., 76/77, 1979, 39; Rubber Age, 103, 1971.

The vulcanisation of these elastomers can be achieved by ionic methods as described in U.S. Pat. No. 3,876,654, U.S. Pat. No. 4,259,463, EP 0 335 705 or in review Prog. Polym. Sci., 1989, 14, 251. or in “Fluoroelastomers. A. Van Cleeff. Dans Modern Fluoropolymers, Edited by John Scheirs. John Wiley & Sons, New York, 1997. pp. 597-614.”

The entire range of relative percentages of the diverse copolymers that can be synthesised from the used fluorinated monomers, leading to the formation of fluorinated copolymers and terpolymers, was studied.

The products were analysed by NMR of ¹H and ¹⁹F. This analysis method allowed the molar percentages of the comomers introduced in the products to be known without ambiguity. For example, we have perfectly established that based on the characterised microstructures given in the literature (Polymer, 1987, 28, 224 and J. Fluorine Chem., 1996, 78, 145) the relationship between characteristic signals of the copolymers HFP/PFSO₂F (see Table 1) and terpolymers HFP/PFSO₂F/VDF (table 2) in NMR of ¹⁹F and the structure of the products. The chemical displacements of different fluorinated groups are indicated in Tables 1 and 2 below.

The molar percentages of HFP and VDF in the copolymers and the terpolymers were determined using Equations 1 and 2 respectively.

$$\begin{matrix}HFP molar \% = \frac{( {I}_{- 71} + {I}_{- 75} ) / 3}{( \begin{matrix}{I}_{- 83} + {I}_{- 91} + {I}_{- 92} + {I}_{- 93} + {I}_{- 95} + \\ {I}_{- 108} + {I}_{- 110} + {I}_{- 113} + {I}_{- 116} + {I}_{- 127}\end{matrix} ) / 2 + ( {I}_{- 71} + {I}_{- 75} ) / 3 + ( {I}_{- 112} ) / 2} \\ \begin{matrix}where {I}_{- i} is the value of the integral of the signal situated \\ at - i ppm in the NMR spectrum of {}^{19} F .\end{matrix} & Equation 1 \\ VDF molar \% = \frac{( \begin{matrix}{I}_{- 83} + {I}_{- 91} + {I}_{- 92} + {I}_{- 93} + {I}_{- 95} + \\ {I}_{- 108} + {I}_{- 110} + {I}_{- 113} + {I}_{- 116} + {I}_{- 127}\end{matrix} ) / 2}{( \begin{matrix}{I}_{- 83} + {I}_{- 91} + {I}_{- 92} + {I}_{- 93} + {I}_{- 95} + \\ {I}_{- 108} + {I}_{- 110} + {I}_{- 113} + {I}_{- 116} + {I}_{- 127}\end{matrix} ) / 2 + \\ ( {I}_{- 71} + {I}_{- 75} ) / 3 + ( {I}_{- 112} ) / 2} \\ \begin{matrix}where {I}_{- i} is the value of the integral of the signal situated \\ at - i ppm in the NMR spectrum of {}^{19} F .\end{matrix} & Equation 2\end{matrix}$$

TABLE 1
NMR characterisation of ¹⁹F of HFP/PFSO₂F copolymers

| | Chemical |
|---|---|
| | displacement |
| Structure | (ppm) |
| —SO₂F | +45 |
| —PFSO₂F—CF₂CF(CF₃)—PFSO₂F— | −71 to −75 |
| —OCF₂CF(CF₃)OCF₂CF₂SO₂F | −77 to −80 |
| —OCF₂CF(CF₃)OCF₂CF₂SO₂F | −112 |
| —CF₂CF(OR_{F}SO₂F)—CF₂CF(OR_{F}SO₂F)— | −117 |
| —PFSO₂F—CF₂CF(CF₃)—PFSO₂F— | −118 |
| —CF₂CF(CF₃)—CF₂CF(OR_{F}SO₂F)— | −122 |
| —CF(CF₃)CF₂—CF₂CF(OR_{F}SO₂F)— | −125 |
| —OCF₂CF(CF₃)OC₂F₄SO₂F | −144 |
| —PFSO₂F—CF₂CF(CF₃)—PFSO₂F— | −175 to −185 |

TABLE 2
NMR characterisation of ¹⁹F VDF/HFP/PFSO₂F terpolymers

| | Chemical |
|---|---|
| | displacement |
| Structure | (ppm) |
| —SO₂F | +45 |
| —CH₂CF₂—CF₂CF(CF₃)—CF₂CH₂— | −71 |
| —CH₂CF₂—CP₂CF(CF₃)—CH₂CF₂— | −75 |
| —OCF₂CF(CF₃)OCF₂CF₂SO₂F | −77 to −80 |
| tBuO—CF₂CH₂— | −83 |
| —CH₂CF₂—CH₂CF₂—CH₂CF₂— | −91 |
| —CF₂CF(R_{F})—CH₂CF₂—CH₂CF₂— | −92 |
| —CF₂CF(R_{F})—CH₂CF₂—CH₂CF₂—CF₂CF(R_{F})— | −93 |
| —CH₂CF₂—CH₂CF₂—CF₂CH₂— | −95 |
| —CF₂CF(OR_{F}SO₂F)—CH₂CF₂—CF₂CF(OR_{F}SO₂F)— | −108 |
| —CH₂CF₂—CH₂CF₂—CF₂CF(R_{F})— | −110 |
| —OCF₂CF(CF₃)OCF₂CF₂SO₂F | −112 |
| —CH₂CF₂—CH₂CF₂—CF₂CH₂— | −113 |
| —CH₂CF₂—CF₂CH₂—CH₂CF₂— | −116 |
| —CH₂CF₂—CF₂CF(CF₃)—CH₂CF₂— | −118 |
| —CH₂CF₂—CF₂CF(OR_{F}SO₂F)—CH₂CF₂— | −122 |
| —CH₂CF₂—CF₂CF(OR_{F}SO₂F)—CH₂CF₂— | −125 |
| —CH₂CF₂—CF₂CF(OR_{F}SO₂F)—CF₂CH₂— | −127 |
| —OCF₂CF(CF₃)OC₂F₄SO₂F | −144 |
| —CH₂CF₂—CF₂CF(CF₃)—CF₂CH₂— | −183 |
| —CH₂CF₂—CF₂CF(CF₃)—CH₂CF₂— | −184 |

The data from Tables 1 and 2 highlights the diades HFP/PFSO₂F, VDF/PFSO₂F and HFP/VDF as well as the sequences head-to-tail and head-to-head of the VDF units (respectively at −91 and −113, −116 ppm).

The copolymers with these compositions can find uses in the preparation of components of fuel cells such as membranes, O-rings, pump casings, diaphragms possessing excellent resistance to fuels, gasoline, t-butyl methyl ether, alcohol and motor oil, which are combined with good elastomeric properties, and particularly very good resistance at low temperatures. Another advantage of these copolymers is that they can be reticulated in the presence of conventional agents.

Thus the present process comprises several interesting advantages. It should be known:
it is carried out in a batch operating mode;
it is carried out in solution using classic commercially available organic solvents;
it comprises a radical polymerisation in the presence of commercially available classical initiators.

The following examples are given to illustrate the preferred embodiments of the invention, and should under no circumstances be considered as limiting the scope of the set invention.

### EXAMPLE 1

### Copolymerisation of HFP/PFSO₂F

### Initial Molar Percentages 80.0/20.0

A Carius tube in borosilicate of considerable thickness (length, 150 mm; interior diameter, 16 mm; thickness, 2.0 nm; for a total volume of 14 cm³) containing 0.1158 g (0.50 mmol) of t-butyl peroxypivalate at 75%, 2.21 g (4.96 mol) of perfluoro(4-methyl-3,6-dioaoct-7-ene) sulfonyl fluoride (PFSO₂F) and 2.25 g (0.030 mol) acetonitrile and are connected to a vacuum pump system and purged three times with helium through primary vacuum cycles (100 mm Hg)/helium. Then, after at least five freezing/thawing cycles to eliminate dissolved oxygen is solution, 3.00 g (0.020 mol) of hexafluoropropene (HFP) is trapped in a frozen tube in a liquid nitrogen and acetone bath and the introduced mass in determined by a double weighing. The tube still immersed in the cold bath is sealed and placed in the cavity of a furnace and agitation at 75° C. for 6 hours.

After the copolymerisation, the tube is frozen in liquid nitrogen and then opened. 1.80 g of gas that has not reacted is then trapped. This permits us to deduce the mass conversion rate of HFP according to the following expression:

$$\frac{{m}_{HFP} - 1 \text{,} 80}{{m}_{HFP}} = 40 \%$$

where m_{HFP} represents the initial mass of HFP that was introduced.

Then, the yellowish liquid obtained is added dropwise into 35 mL of vigorously mixed cold pentane. After being left 1 hour at 0-5° C., the mixture is poured into a separatory funnel and decanted. The clear colorless supernatant is removed while the heavy yellow phase is dried at 70° C. under 1 mmHg for 2 hours. 1.67 g of very viscous and clear liquid is obtained which corresponds to a mass output of 32%. IRTF analysis (IR Nicolet 510 P) of this copolymer reveals the following characteristic vibrations:

IRTF (KBr, cm⁻¹): 1 100-1 300 (ν_{CF}); 1 465 (ν_{SO2F}).

The composition of the copolymer (that is to say the molar percentages of the two comonomers of the copolymer or the three comonomers of the terpolymer) were determined by NMR of ¹⁹F (200 or 250 MHz) at ambient temperature, acetone or deuterated DMF being the reference solvents. The reference for NMR of ¹⁹F is CFCl₃. The experimental conditions for the NMR were the following: a flip angle of 30°, a collection time of 0.7 s, a pulse time of 5 s, 128 accumulated scans and a pulse width of 5 μs.

In addition, this NMR analysis of ¹⁹F allows us to ensure that the copolymer does not contain any unreacted PFSO₂F, which is shown by the absence of a signal at −137.5 ppm, characteristic of one of the ethylene fluoride atoms of the sulfonated monomer.

As an example, the different signals of the NMR spectrum of ¹⁹F and their attributes are given in Table 1. We can be sure of the total reactivity of the sulfonated monomer by the absence of the characteristic signals located at −137.5 ppm attributed to one the ethylene fluoride atoms. According to the integrated signals of the NMR corresponding to each comonomer, the respective molar percentages of HFP/PFSO₂F in the copolymer are 31.8/68.2 according to Equation 1. The copolymer has the appearance of a colorless resin and a T_{g} of −48° C. The thermogravimetric analysis (TGA) reveals that the copolymer is stable thermally. To this end, the temperature required for a 5% degradation in air is 155° C. (Table 3).

### EXAMPLE 2

### Terpolymerisation HFP/VDF/PFSO₂F

### Initial Molar Percentages 23/59/18

In a 300 mL Hastelloy reactor (HC 276) TM, equipped with an inlet gas valve, a salting-out valve, a pressure indicator, and a rupture disc of HC 276 TM and a magnetic mixer turning at 700 rpm, are introduced, (48.5 g (0.11 mol) of PFSO₂F); 1.10 g (4.7 mmol) t-butyl peroxypivalate at 75% and 149.8 g of methyl acetate. The reactor is closed and its sealing is verified. The following cycle is conducted three times: the reactor is placed under vacuum, then nitrogen at 10-15 bars is introduced. These cycles allow the degassing of the solution. This is followed by a vacuum of 20 mmHg in the reactor. The reactor is then placed in an acetone/liquid nitrogen bath so as to obtain an interior reactor temperature close to −80° C. The following are introduced successively, 21.0 g HFP (0.14 mol) then 23.0 g vinylidene fluoride (VDF) (0.36 mol) by double weighing of the reactor. The reactor is then placed in an oil bath progressively heated to a temperature of 75° C. and maintained for three hours. The maximum reaction pressure attained is 13 bars. After six hours at the reaction temperature, the pressure observed is 7 bars. After the reaction, the reactor is placed in an ice bath for 30 minutes, degassing then shows a loss of 2.3 g of gas that was not reacted, which corresponds to a conversion rate of gaseous monomers of approximately 95%. The reaction broth is treated as previously by precipitating in cold pentane and drying. The mass of recovered copolymer is 68.2 g. The obtained terpolymer is a viscous orange liquid. The mass output is 74%. The IRTF analysis (IR Nicolet 510 P) of this terpolymer reveal the characteristic vibrations:

IRTF (KBr, cm⁻¹): 1 100-1 300 (ν_{CF}); 1 467 (ν_{SO2F}).

The characterisation by NMR ¹⁹F (Table 2) shows the absence of trace sulfonated monomer and allows us to know the molar percentages if the three comonomers in the terpolymer equal 10% HFP, 71% VDF and 19% of the sulfonated monomer (PFSO₂F) according to the Equations 1 and 2. The terpolymer has a T_{g} of −43° C. The thermogravimetric analysis (TGA) shows that the copolymer is very stable thermally. To this end, the temperature required for a 5% degradation in air is 260° C. (Table 3).

Other copolymerisations of HFP/PFSO₂F and terpolymerisations of HFP/VDF/PFSO₂F (experimental details and results) are presented in Table 3.

TABLE 3
Operating conditions and results of radical polymerisations of HFP with PFSO₂F and VDF

| | Mass of | Mass of | Mass of | Mass of | | Initial | Initial | Initial |
|---|---|---|---|---|---|---|---|---|
| | VDF | HFP | PFSO₂F | solvent | C₀ | VDF | HFP | PFSO₂F |
| Example^{a} | (g) | (g) | (g) | (g) | (%) | (% mol.) | (% mol.) | (% mol.) |
| 1 | 0 | 3.00 | 2.21 | 2.25^{b} | 2.0 | 0 | 80.0 | 20.0 |
| 2 | 23.0 | 21.0 | 48.5 | 150^{c} | 1.0 | 59.0 | 23.0 | 18.0 |
| 3 | 0 | 2.51 | 5.05 | 2.65^{b} | 2.0 | 0 | 59.3 | 40.7 |
| 4 | 6.0 | 18.0 | 50 | 150^{c} | 1.0 | 28.6 | 36.9 | 34.4 |
| 5 | 5.9 | 42.0 | 41.7 | 150^{c} | 1.0 | 19.8 | 60.2 | 20.0 |
| 6 | 1.9 | 22.2 | 45.0 | 150^{c} | 1.0 | 10.5 | 53.5 | 36.0 |
| 7 | 5.9 | 14.0 | 40.0 | 150^{c} | 1.0 | 33.5 | 34.0 | 32.5 |

| | | | | Gaseous | | | |
|---|---|---|---|---|---|---|---|
| | VDF | HFP | PFSO₂F | monomer | Mass | | T_{degradation} |
| | copolymer | copolymer | copolymer | conversion | output | T_{g} | 5% inair |
| Example^{a} | (% mol.) | (% mol.) | (% mol.) | (%) | (%) | (° C.) | (° C.) |
| 1 | 0 | 31.8 | 68.2 | 40 | 32 | −48 | 155 |
| 2 | 71.0 | 10.0 | 19.0 | 95 | 74 | −43 | 260 |
| 3 | 0 | 21.3 | 78.7 | 11 | 6 | −41 | 150 |
| 4 | 43.2 | 14.3 | 42.5 | 85 | 58 | −41 | 195 |
| 5 | 46 | 24 | 30.0 | 79 | 25 | −36 | 185 |
| 6 | 31.6 | 17.4 | 51.0 | 68 | 18 | −45 | 205 |
| 7 | 37.7 | 13.2 | 49.1 | 76 | 41 | −38 | 195 |

^{a}Temperature of 75° C., for a period of 3 to 6 hours, in the presence of t-butyl peroxypivalate
^{b}Acetonitrile
^{c}Methyl acetate
C₀ = [initiator]₀/([HFP]₀ + [VDF]₀ + [PFSO₂F]₀). The value of C₀ varies generally between 0.1 and 2%.

The advantages related to the present invention are mainly the following:
1) The synthesis process is accomplished in a batch operating mode;
2) The process in question of the present invention is conducted in solution with the use of classical organic solvents, easily obtained and commercially available;
3) The process of the present invention consists of a radical polymerisation in the presence of classical initiators, which are commercially available;
4) Tetrafluoroethylene (TFE) is not used in the present invention;
5) The perfluorinated olefin which makes up a part of the composition of the fluorinated elastomers of the present invention is hexafluoropropene; it is less expensive and less dangerous than TFE and gives the obtained elastomers good resistance to oxidation, to chemical agents, to polar solvents and to gasoline;
6) The fluorinated elastomers of the present invention can be prepared from PFSO₂F monomer of which the copolymerisation with HFP and the terpolymerisation with HFP and VDF have never been an object of work described in the literature. Moreover, this sulfonated monomer due to the nature of the sulfonyl fluoride functionality, allows the creation of reticulation sites in the elastomers;
7) The synthesised fluorinated elastomers of the present invention also contain vinylidene fluoride, which is much less expensive and less dangerous than TFE; this monomer helps to reduce the glass transition temperature (T_{g});
8) The fluorinated elastomers obtained by this process have very low glass transition temperatures, varying from −36 to −48° C.
9) The fluorinated elastomers of the said invention, given the presence of VDF-HFP in the terpolymers, can be reticulated by diamines, by bis-amidoximes or polyphenols.

Although the present invention was described with the aid of specific embodiments, it is understood that many variations and modifications can be attached to these embodiments, and the present application aims to cover such modifications, uses or adaptations of the present invention, generally according to the principals of the invention and including all variations of the present description which will become known or conventional in the field of activity in which the present invention is found, and which can be applied to the essential elements mentioned below, and in accordance with the breadth of the following claims.

1. A fluorinated sulfonated elastomer, not containing tetrahydrofluoroethylene or monomers containing siloxane groups, and having a glass transition temperature (T_{g}) between −36 and −50° C., and comprising a hexafluoropropene (HFP) copolymer, and a perfluorosulfonyl ethoxy propyl vinyl ether fluoride (PSEPVE) or perfluoro(4-methyl-3,6-dioxaoct-7-ene) sulfonyl fluoride (PFSO₂F).

2. A fluorinated sulfonated elastomer according to claim 1, containing 20 to 32 mole % HFP and 80 to 68 mole % PSEPVE or PFSO₂F.

3. A fluorinated sulfonated elastomer according to claim 1, also containing vinylidene fluoride (VDF), and/or at least one fluorinated alkene and/or at least one vinyl perfluorinated ether.

4. A fluorinated sulfonated elastomer according to claim 1, containing 10 to 32 mole % HFP, 19 to 79 mole % of PSEPVE or PFSO₂F and 0 to 71 mole % VDF and/or at least one fluorinated alkene and/or at least one vinyl perfluorinated ether.

5. A fluorinated sulfonated elastomer according to claims 1, 2, 3 or 4 which can be reticulated.

6. Polymer electrolytes, ionomers, components of fuel cells (such as membranes and seals), joints, hose connections, pipes, O-rings, pump casings, diaphragms, piston heads, for applications in the aeronautic, petroleum, automobile, mining, nuclear and plastic industries comprising elastomers according to any one of claims 1 to 5.

7. A process for the preparation of fluorinated elastomers by copolymerisation of hexafluoropropene with perfluorosulfonyl ethoxy propyl vinyl ether fluoride (PSEPVE) or perfluoro(4-methyl-3,6-dioxaoct-7-ene) sulfonyl fluoride (PFSO₂F), characterised in that the preparation is conducted through a radical copolymerisation in the presence of one organic initiator at a temperature between 20 and 200° C., for a period of time between 3 and 6 hours, and at an initial pressure between 2 and 100 bars, and allowing the said initial pressure to fall progressively as the monomers are consumed.

8. A process according to claim 7, characterised in that the radical copolymerisation also involves at least vinylidene fluoride and/or at least one fluorinated alkene and/or at least one vinyl perfluorinated ether.

9. A process according to claim 8, wherein the vinyl perfluorinated ether is selected from the group consisting of perfluoromethyl vinyl ether, perfluoroethyl vinyl ether and perfluoropropyl vinyl ether.

10. A process according to claim 8, wherein the vinyl perfluorinated ether is perfluomethyl vinyl ether or perfluoropropyl vinyl ether.

11. A process according to claim 8, wherein the perfluoroalkoxyalkyl vinyl ether is selected from the group consisting of perfluoro(2-n-propoxy)propyl vinyl ether, perfluoro(2-methoxy)propyl vinyl ether, perfluoro(3-methoxy)propyl vinyl ether, perfluoro(2-methoxy)ethyl vinyl ether, perfluoro(3,6,9-trioxa-5,8-dimethyl)-dodeca-1-ene, perfluoro(5-methyl-3,6-dioxo)-1-nonene, alone and in combination.

12. A process according to claim 7, wherein the radical copolymerisation is conducted in solution and in the presence of a solvent.

13. A process according to claim 12, wherein the solvent is selected from the group consisting of:
a) esters of the formula R—COOR′ where R and R′ represent independently C₁₋₅ alkyl or OR″ where R″ represents an alkyl group containing 1 to 5 carbon atoms, R can also represent H,
b) the fluorinated solvents of which perfluoro-n-hexane, and
c) solvents selected from the group consisting of methyl acetate, 1,2-dichloroethane, isopropanol, tertiobutanol, acetonitrile and butyronitrile.

14. A process according to claim 13, wherein R=H or CH₃ and R′=CH₃, C₂H₅, i-C₃H₇ or t-C₄H₉.

15. A process according to claim 13, wherein the solvent is a fluorinated solvent selected from the group consisting of ClCF₂CFCl₂, n-C₆F₄, n-C₄F₁₀ and perfluoro-2-butyl-tetrahydrofuran.

16. A process according to claim 13, wherein the solvent is selected from the group consisting of methyl acetate and acetonitrile.

17. A process according to claim 7, wherein the temperature is situated between 55 and 80° C.

18. A process according to claim 7, wherein the initial pressure is between of 10 to 100 bars.

19. A process according to claim 7, wherein the initial pressure is between 20 and 40 bars.

20. A process according to claim 7, wherein the radical copolymerisation is carried out by a polymerisation, selected from the group consisting of: emulsion, miniemulsion, microemulsion, mass, suspension, microsuspension and solution, polymerisation.

21. A process according to claim 8, wherein the copolymerisation of hexafluoropropene is carried out with PSEPVE or PFSO₂F, at least on vinyl perfluorinated ether and at least one fluorinated alkene, the fluorinated alkene being a compound of structure R₁R₂C═CR₃R where R₁, R₂, R₃ and R₄ such that at least one among them is fluorinated or perfluorinated.

22. A process according to claim 21, wherein the fluorinated alkene is selected from the group consisting of vinyl fluoride, trifluoroethylene, chlorotrifluoroethylene, bromotrifluoroethylene, 1-hydropentafluoropropylene, hexafluoroisobutylene, 3,3,3-trifluoropropene, 1,2-dichlorodifluoroethylene, 2-chloro-1,1-difluoroethylene, 1,2-difluoroethylene, 1,1-difluorodichloroethylene.

23. A process according to claim 7, wherein the copolymerisation is carried in batch mode.

24. A process according to claim 7, wherein the organic initiator is selected from a group consisting of azo compounds, dialkyl peroxydicarbonates, alkyl peroxides, alkyl hydroperoxides, alkyl perbenzoates and alkyl peroxypivalates.

25. A process according to claim 7, wherein the organic intiator is selected from a group consisting of acetylcyclohexanesulfonyl peroxide, dibenzoyl peroxide, dicumyl peroxide, diethyl peroxydicarbonate, di-isopropyl peroxydicarbonate, t-butyl peroxypivalate, t-amyl peroxypivalate and t-butyl cyclohexyl peroxydicarbonate.

26. A process according to claim 7, wherein the initial molar ratio between initiator and monomers is between 0, 1 and 2%.

27. A process according to claim 20, wherein the copolymerisation is carried out in emulsion.

28. A process according to claim 27, wherein the copolymerisation is carried out in the presence of a surfactant.

29. A process according to claim 28, wherein the surfactant is anionic, cationic or non ionic.

30. A process according to claim 29, wherein the surfactant is selected from a group consisting of ammonium salts and perfluorinated sulfonates.

31. A process according to claim 7, wherein the copolymerisation is carried out in the presence of chain transferring agents.
